(19) United States
(12) Patent Application Publication
(10) Pub. No.: US 2005/0000763 A1
(43) Pub. Date: Jan. 6, 2005

(54) Auxiliary device for releasing the parking brake during failing energy supply

(76) Inventors: Joerg Haffelder, Bad Rappenau (DE); Dieter Blattert, Kirchheim/Neckar (DE); Frank Baehrle-Miller, Schoenaich (DE); Bernhard Menacher, Abstatt (DE)

Correspondence Address: KENYON & KENYON, ONE BROADWAY, NEW YORK, NY, 10004, US

(21) Appl. No.: 10/855,104

(22) Filed: May 26, 2004

(30) Foreign Application Priority Data
Jun. 2, 2003 (DE) 103 24 809.9

(51) Int. Cl. F16D 65/36

(52) U.S. Cl. 188/162

(57) ABSTRACT

An electrically controlled parking brake for motor vehicles, including an operating element for operating the parking brake and a control unit, which controls an actuator of the parking brake when the operating element is operated. The parking brake function is ensured, upon failure of the electrical supply, if the parking brake includes a connecting device for connecting an auxiliary voltage source, with the aid of which the parking brake may be operated in an auxiliary manner.

### FIELD OF THE INVENTION

The present invention relates to an electrically driven parking brake for motor vehicles.

### BACKGROUND INFORMATION

A parking brake is used especially to secure a parked vehicle from rolling away. According to regulations in force, the vehicle is held in place mechanically and without energy being applied when the parking brake is applied. Normally, this is implemented by a mechanical locking device.

Electrically operated parking brakes include an operating element, such as a push button, for operating the parking brake. A control unit connected to the operating element detects a parking brake command and accordingly activates an actuator, such as an electric motor or a hydraulic pump, in order to apply the parking brake or to release it. In a hydraulic or pneumatic parking brake system, the brake may be locked by a mechanical locking device, so that the vehicle is held in place without the application of energy. The locking device may be operated by hydraulic or pneumatic pressure. In this context, it is necessary to control magnetic valves electrically.

FIG. 1 shows such a parking brake system, known from other systems, in a schematic representation. The parking brake includes an operating element 7 (push button), a control unit 6 and a hydraulic unit 5. When operating element 7 is operated, the control unit activates hydraulic unit 5, or, more accurately, an hydraulic pump which generates pressure in a hydraulic line 9, which is used both for operating wheel brake 11 and for operating a locking device 12. The parking brake also includes a hydraulic valve 10 which is activated by control unit 6 in order to lock or to release locking device 12.

The system is supplied with current from the vehicle electrical system by a battery 8. When the electrical energy supply fails, it is no longer possible to lock the parking brake (in order, for example, to park the vehicle safely), or to release the parking brake if the vehicle is parked (in order, for example, to tow it away), since valve 10 may no longer be activated.

### SUMMARY OF THE INVENTION

It is an object of the present invention to create a device with the use of which the parking brake may be operated even during failed energy supply.

The present invention provides, for a parking brake system, a connecting device for connecting an auxiliary voltage source with which the parking brake is able to be operated on an auxiliary basis if the electrical supply fails. Thereby the parking brake may be locked or released using on-board arrangement, such as a battery, even if there is a total breakdown of the vehicle electrical system.

According to a first exemplary embodiment of the present invention, the connecting device includes terminal contacts to connect an auxiliary battery (i.e. one or more 1.5V or 9V batteries). In this exemplary embodiment, the battery may be connected directly to the terminal contacts. This may provide that no further auxiliary arrangement, such as, for instance, a battery adapter, are required.

According to a second exemplary embodiment of the present invention, the connecting device includes a battery adapter which, for example, is able to be plugged into a plug connection. In the case of the battery adapter according to the present invention, especially a device is involved into which a battery is inserted or into onto which it may be plugged. The battery adapter, for example, may be configured in such a manner that it may be able to be plugged onto a plug connector of a cable harness of the vehicle, such as the control unit cable harness.

According to a third exemplary embodiment of the present invention, the connecting device includes a terminal contact for connecting a cable such as a battery jumper cable or the cable of an external starting device. The terminal contact may be, in this instance, configured in such a manner that the cable may simply be clamped on, and includes, for example, the shape of a lug.

The connecting device according to the present invention may be arranged, for example, in the engine compartment, for example, on the control unit of the parking brake. However, the connecting device may be arranged in the passenger compartment. This may provide that a battery may conveniently be plugged into it by the driver.

The auxiliary battery (with or without adapter) may also be permanently connected to the parking brake system. A switch operated by the driver in an emergency may, for instance, be provided for switching on or off the auxiliary energy supply. The failure of the energy supply may also be detected automatically, and the energy supply may be activated automatically via the auxiliary battery, if an appropriate sensor system and circuit are provided.

The connecting device for the auxiliary voltage source may be electrically connected in such a manner that at least the valve for locking or releasing the parking brake may be supplied with auxiliary energy. In particular while using a battery, the remaining electrical system of the vehicle may not be supplied with auxiliary energy.

The connecting device may also be set up in such a manner that, during normal operation, no vehicle electrical system voltage is present at the contacts of the connecting device.

### BRIEF DESCRIPTION OF THE DRAWINGS

FIG. 1 shows a schematic basic circuit diagram of an electrically controlled parking brake according to other systems.

FIG. 2 shows a connecting device for connecting an auxiliary voltage source according to a first exemplary embodiment of the present invention.

FIGS. 3a-c shows a connecting device for connecting an auxiliary voltage source according to a second exemplary embodiment of the present invention.

FIG. 4 shows a connecting device for connecting an auxiliary voltage source according to a third exemplary embodiment of the present invention.

FIG. 5 shows a connecting device for connecting an auxiliary voltage source according to a fourth exemplary embodiment of the present invention.

FIGS. 6a and 6b shows a connecting device for connecting an auxiliary voltage source according to a fifth exemplary embodiment of the present invention.

### DETAILED DESCRIPTION

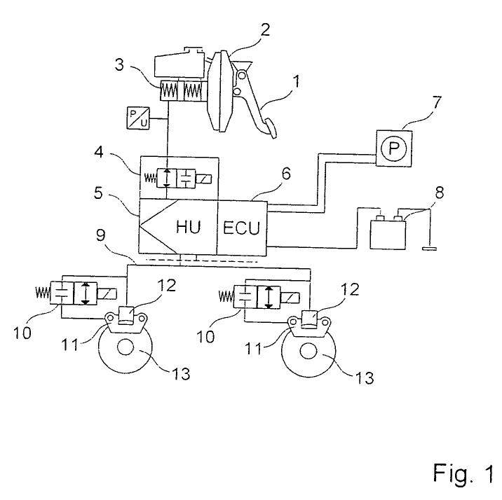

Reference is made to the introductory part of the specification regarding the clarification of FIG. 1.

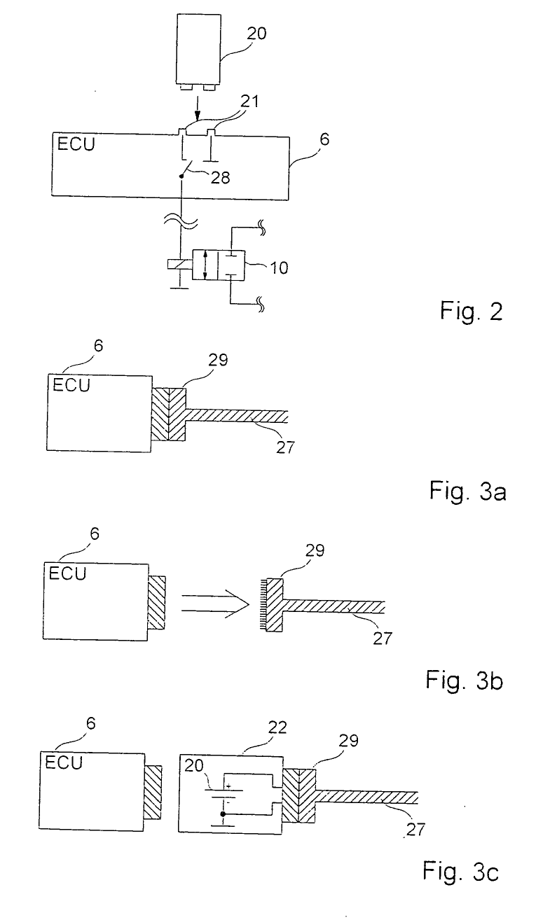

FIG. 2 shows a cutout of a parking brake system, including a control unit 6, which is connected to a valve 10 via a control line. For the purpose of releasing or locking the parking brake, valve 10 is controlled by control unit 6. In normal operation, control unit 6 is supplied with electrical energy from the vehicle's electrical system by vehicle battery 8. When there is a failure of the electrical energy supply, such as based on a defective vehicle battery 8, valve 10 may no longer be operated, and consequently the parking brake may no longer be released or locked. In order to secure emergency operation even in this case, the control unit includes a connecting device including two terminals 21 for connecting an auxiliary battery 20. The auxiliary battery 20 may be, for instance, several 1.5V batteries or one commercial 9V battery which may be plugged onto terminals 21. The battery may, for instance, be added to the vehicle's tool set.

Terminals 21 are connected electrically inside control unit 6 in such a manner that valve 10, which is necessary for the operation of locking device 12, may be supplied directly with current. Additional users, e.g., the vehicle's electrical system, are not supplied with auxiliary energy in this context. Terminals 21 are furthermore connected in such a manner that, in normal operation, electrical system voltage is not present at them. The corresponding connection may, for example, be implemented by semiconductor switches such as transistors or diodes. The connection is represented symbolically by a switch 28.

The pressure required for locking or releasing the parking brake may be built up by the driver of the vehicle by operating brake pedal 1 (see FIG. 1), and the parking brake may be appropriately released or locked.

FIGS. 3a-3c show a exemplary embodiment of the present invention in which a battery adapter 22 is plugged onto a plug connector 29 of the vehicle's cable harness 27, in order to supply the parking brake with auxiliary energy.

FIG. 3a shows control unit 6 of the parking brake together with a vehicle cable harness 27 connected to it. In order to connect adapter 22, cable harness 27, as shown in FIG. 3b, is pulled away (unplugged) from control unit 6. Adapter 22 may then be plugged onto plug connector 29 of vehicle cable harness 27 (see FIG. 3c).

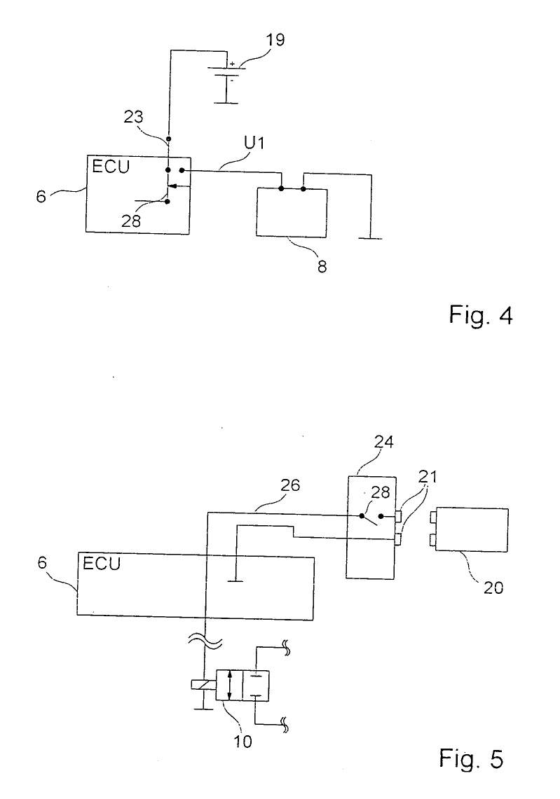

Battery adapter 22 includes a battery 20 on the inside of adapter 22 (auxiliary battery 20 could also be plugged on the outside). Battery adapter 22 is connected in such a manner that, by plugging on adapter 22, valves 10 which is necessary for locking or releasing the parking brake, are directly supplied electrically. The driver of the vehicle is able to operate locking device 12 by appropriate pressure buildup via brake pedal 1, and is consequently able to lock or release the parking brake. The cable harness adapter including an exchangeable battery may be put with the vehicle's tool kit. FIG. 4 shows an additional exemplary embodiment of the present invention, in which the connecting device is configured as connector 23 for clamping on a cable. An external voltage source, such as an external starting device, a 12V vehicle battery or a power pack may therefore be connected in a manner with the aid of a cable.

Terminal 23 may be connected in such a manner that the components of the parking brake system, especially control unit 6, hydraulic unit 5 and valves 10 are supplied with auxiliary energy. The driver is therefore in a position to lock or release the parking brake in the customary manner, by operating operating element 7 in the vehicle's interior. The remainder of the electrical system may not be supplied with auxiliary energy. This may provide that the parking brake still functions even when serious defects or short circuits are present in the vehicle's electrical system, and connecting the external starting device to the electrical system with the aid of a battery jumper cable is no longer possible.

The electrical connection inside control unit 6, which is shown symbolically by a switch 28, is able to be implemented using a diode device.

FIG. 5 shows a connecting device corresponding to FIG. 1, which, however, may be operated from the passenger compartment. For this purpose, a connecting part 24 including terminals 21 is arranged in the passenger compartment. Connecting part 24 is connected to control unit 6 and valve 10 via lines 26, in order to supply valve 10 with current in an emergency operation.

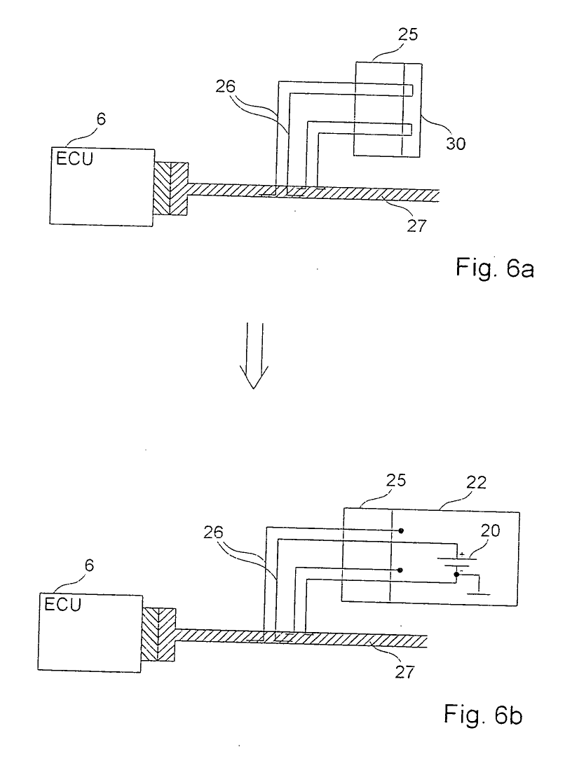

FIGS. 6a, 6b show a exemplary embodiment of the present invention in which the connecting device is implemented in the form of an adapter plug 25 that is additionally connected to cable harness 27, onto which adapter 22 is plugged. Adapter plug 25 is connected via lines 26 to cable harness 27, and is wired in such a manner that a valve 10 is electrically supplied in response to the connection of an auxiliary voltage source.

In normal operation, plug adapter 25 is protected by a cap 30. When the electrical supply fails, cap 30 may be pulled off and a battery adapter 22 is plugged onto plug connector 25 (see FIG. 6b), in order thus to make possible the operation of the parking brake.

Connecting device 22, 25 is in this case connected in such a manner that only valve 10, and not control unit 6 is supplied with current. The plug connector 25 may be arranged in the passenger compartment. Thereby, in particular, the driver is not forced to disconnect cable harness 27 from control unit 6, as is required in the exemplary embodiment of FIG. 3.

1. An electrically controlled parking brake for a motor vehicle, comprising:
an operating element for operating the electrically controlled parking brake;
a control unit, which controls an actuator of the electrically controlled parking brake in response to operation of the operating element; and
a connecting device for connecting an auxiliary voltage source;
wherein via the connecting device, the electrically controlled parking brake being operated in an auxiliary manner when an electrical supply fails.

2. The electrically controlled parking brake of claim 1, wherein the connecting device includes terminal contacts for connecting an auxiliary battery.

3. The electrically controlled parking brake of claim 1, wherein the connecting device includes a terminal contact for connecting a cable.

4. The electrically controlled parking brake of claim 1, wherein the connecting device includes a plug connector for connecting a battery adapter.

5. The electrically controlled parking brake of claim 1, wherein the connecting device includes a battery adapter which is plugged onto a plug connector.

6. The electrically controlled parking brake of claim 5, wherein the battery adapter is configured in such a manner that it is plugged onto a standard cable harness plug.

7. The electrically controlled parking brake of claim 1, wherein the connecting device is arranged at the control unit.

8. The electrically controlled parking brake of claim 1, wherein the connecting device is arranged in a passenger compartment.

9. The electrically controlled parking brake of claim 1, wherein the connecting device is configured such that a valve of the electrically controlled parking brake is supplied with auxiliary energy.

10. The electrically controlled parking brake of claim 1, wherein the connecting device is electrically connected in such a manner that an electrical system of the motor vehicle is not supplied with auxiliary energy.
